(19) United States
(12) Patent Application Publication
(10) Pub. No.: US 2026/0115894 A1
(43) Pub. Date: Apr. 30, 2026

(54) MOTION TRACKING SYSTEM AND METHOD FOR ROBOTIC EXOSKELETON AND COMPUTER-READABLE STORAGE MEDIUM

(71) Applicant: Futronics (NA) Corporation, Pasadena, CA (US)

(72) Inventors: LUIS ALFREDO GUZMAN, Pasadena, CA (US); Wenda Xu, Pasadena, CA (US); Weide Zhang, Pasadena, CA (US); Chengkun Zhang, Pasadena, CA (US)

(21) Appl. No.: 18/929,226

(22) Filed: Oct. 28, 2024

(51) Int. Cl. B25J 9/00

(52) U.S. Cl. CPC B25J 9/0006

(57) ABSTRACT

A motion tracking system for a robotic exoskeleton includes a computer device configured that is to: control a camera to capture the robotic exoskeleton when the robotic exoskeleton moves to obtain a plurality of images; for each image of the images, detect at least one of the two-dimensional markers in the image, obtain the position information and the appearance information contained in the at least one of the two-dimensional markers, determine an identity of the detected at least one of the two-dimensional markers based on the obtained appearance information, and obtain, based on the obtained position information, corresponding three-dimensional position and three-dimensional orientation; and output, by the computer device, the identity, the three-dimensional position and the three-dimensional orientation of the at least one of the two-dimensional markers as a tracking result of the robotic exoskeleton.

### TECHNICAL FIELD

The present disclosure generally relates to robotic exoskeletons, and in particular relates to a motion tracking system and method for a robotic exoskeleton and computer-readable storage medium.

### BACKGROUND

Two-dimensional (2D) markers are visual targets used in computer vision to estimate the three-dimensional (3D) pose (position and orientation) of an object in space. These markers are typically printed patterns (e.g., squares, circles, etc.) with unique designs that allow them to be easily identified by a camera. By analyzing the marker's appearance and location in a 2D image, computer vision algorithms can reconstruct its 3D position and orientation relative to the camera. This is particularly useful for applications like robot navigation, augmented reality, and motion capture.

While 2D markers are a powerful tool for 3D pose estimation, they face some challenges, particularly in real-world environments. These challenges include errors in 3D pose estimation caused by poor handling of reflections and ambient light noise, which makes it difficult for the camera to accurately identify the edges and features of the markers, leading to errors in pose estimation.

Therefore, there is a need to provide a motion tracking system and method for a robotic exoskeleton to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a motion tracking system according to one embodiment.

FIG. 2 is a schematic diagram of a group of 2D markers attached to a robotic exoskeleton.

FIG. 3 is a schematic diagram of a group of 2D markers with one marker blocked.

FIG. 4 is a schematic diagram of a group of 2D markers with a first marker blocked and a second marker that cannot be captured/identified due to a camera angle problem.

FIG. 5 is a photo showing 2D markers attached to different positions of the robotic exoskeleton.

FIG. 6 is a schematic diagram of the motion trajectory of each linkage member of the robotic exoskeleton output by the motion tracking system.

FIG. 7 is an exemplary flowchart of a motion tracking method according to one embodiment.

FIG. 8 is an exemplary flowchart of a motion tracking method according to another embodiment.

FIG. 9 is a schematic block diagram of a computer device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one”embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

In one embodiment, the present disclosure provides a control device for an upper limb rehabilitation exoskeleton (hereinafter referred to as “the exoskeleton”) for controlling the output torque of each joint of the exoskeleton to compensate for the user's intended force, enabling a user to easily rotate the joints of the exoskeleton during rehabilitation of an upper limb of the user.

The present disclosure provides a motion tracking system for a robotic exoskeleton (hereinafter referred to as “exoskeleton”) for tracking the range of motion, position, and speed of the exoskeleton when used by a user by tracking two-dimensional markers on the exoskeleton.

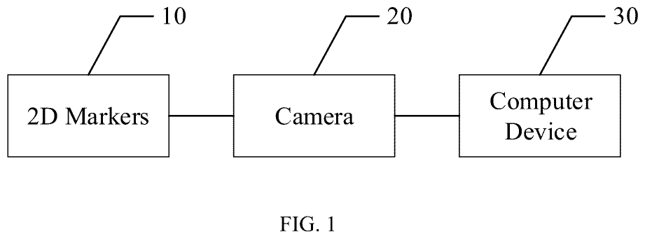

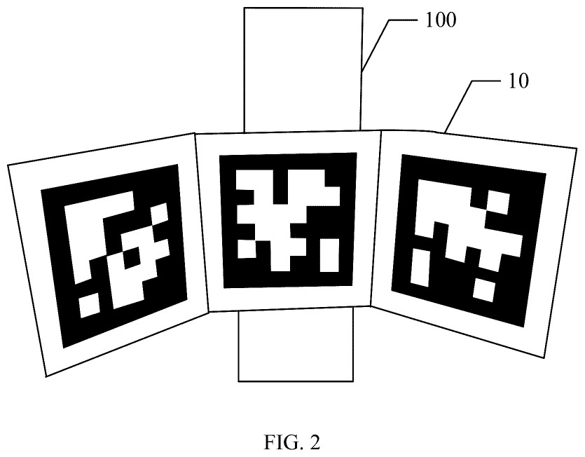

Referring to FIGS. 1 and 2, in one embodiment, an exoskeleton 100 may include computer device 30 that operates with multiple groups of 2D markers 10 and a camera 20. The 2D markers are arranged on the exoskeleton 100. The camera 20 is arranged above and in front of the exoskeleton 100 and can capture the exoskeleton 100. The computer device 30 is electrically coupled to the camera 20 and can control the camera 20 to take pictures of the exoskeleton 100.

In one embodiment, each group of two-dimensional markers 10 may include at least three linked 2D markers, and the 2D markers are not coplanar. That is, the linked two-dimensional markers are respectively in different planes. Each 2D marker 10 contains unique appearance information and its unique position on the exoskeleton.

Each two-dimensional marker 10 can be a 2D pattern printed on paper, and the 2D pattern can be square or circular. In the figures of the present disclosure, the 2D pattern is shown as a square for illustration purposes, but other shapes are not limited. For example, the group of two-dimensional markers in FIG. 2 includes three linked two-dimensional markers, each of which includes a 2D pattern. Specifically, the single paper printed with the three 2D patterns is folded into three non-coplanar portions, each of which has one 2D pattern. The paper can be fixed to the exoskeleton through a fixing member, or directly glued to the exoskeleton. The paper can be fixed to a joint or a movable part of the exoskeleton, so as to facilitate tracking of the motion trajectory of the joint and movable part.

The computer device 30 can control the camera 20 to capture the exoskeleton 100 when the exoskeleton 100 moves to obtain a number of images from the camera 20. For each image of the obtained images, the computer device 30 can detect at least one of the 2D markers in the image, obtain the position information and the appearance information contained in the at least one of the 2D markers, determine an identity of the detected at least one of the 2D markers based on the obtained appearance information, and obtain, based on the obtained position information, corresponding 3D position and 3D orientation. The computer device 30 can then output the identities, the 3D position and the 3D orientation of the 2D markers as a tracking result of the robotic exoskeleton. For example, the computer device 30 can then output the identities, the 3D position and the 3D orientation of the 2D markers on a display device.

In the above-mentioned embodiment, at least three non-coplanar linked two-dimensional markers are arranged on the robotic exoskeleton, this redundancy helps overcome issues caused by single light sources. Even with a single camera, when one or two 2D markers are blocked due to the capturing angle or the influence of a blocking object, the camera can still capture one 3D marker from any angle and any position. Each of the 2D markers contains unique position information and unique appearance information. The computer device can control the camera to capture the exoskeleton in motion and obtain the captured images from the camera. The computer device can identify a 2D marker in each obtained image and obtain the position information and appearance information contained in the 2D marker. The computer device can determine the 3D position and 3D orientation of the 2D marker according to the position information and the appearance information. The 3D position and 3D orientation are used as the tracking result of the robotic exoskeleton, and the tracking result is output through a display device of the computer device, so that the exoskeleton can be tracked in all the working spaces of the exoskeleton. The above-mentioned recognition and tracking of the 2D marker overcome the reflection and noise from the environment, and can reduce the errors of the two-dimensional marker detection and the exoskeleton posture estimation.

In one embodiment, the angle between two adjacent ones of each group of the plurality of groups of two-dimensional markers is greater than 0 degrees and less than or equal to 135 degrees. This can increase the probability that the camera will capture one or both of the 2D markers. In one embodiment, when the at least three linked 2D markers are three in number, among the three linked 2D markers 10, the two angles between the 2D marker located in the middle and the two adjacent 2D markers are equal. The angels are greater than 0 degrees and less than or equal to 135 degrees.

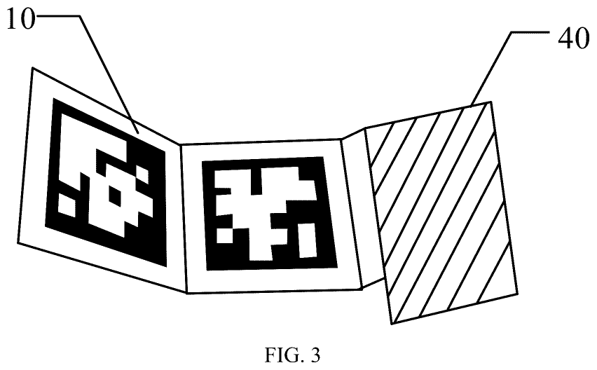

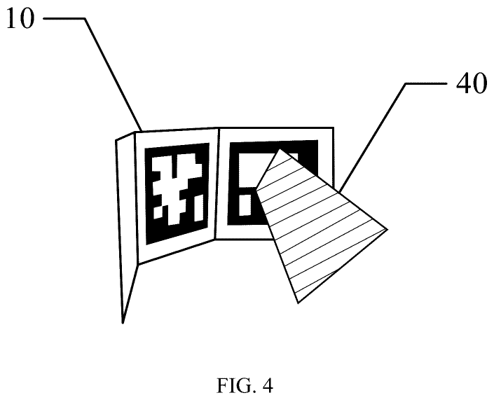

The rightmost 2D marker of the three linked 2D markers 10 in FIG. 3 is blocked by the obstacle 40, while the remaining 2D markers 10 can still be captured by the camera 20. The 2D marker on the right of the three linked 2D markers 10 in FIG. 4 is blocked by the obstacle 40. Meanwhile, the 2D marker on the left cannot be captured by the camera 20 due to the angle problem. However, the 2D marker 10 in the middle can still be captured by the camera 20. In the two scenarios, at least one of the three linked 2D markers will be captured by the camera.

Each 2D marker 10 is unique, including unique appearance information and a unique position on the exoskeleton. Therefore, the identity (e.g., a unique number) of the 2D marker 10 can be determined based on the position and appearance information in the 2D marker 10. In one embodiment, the 2D marker 10 has a black border and a two-dimensional matrix inside that uniquely identifies the 2D marker. The black border can speed up the detection of the 2D marker in the image, and the 2D code inside can uniquely identify the 2D marker. The size of the 2D marker determines the size of the internal matrix, and the size of the 2D marker can be customized.

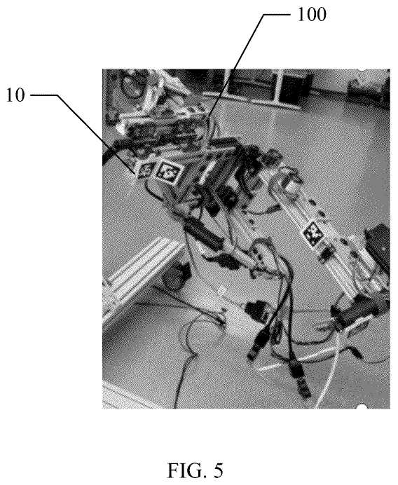

The application scenario is shown in FIG. 5, where three linked 2D markers 10 are attached to an exoskeleton 100. The computer device 30 can be connected to the camera 20 by wire or wirelessly, obtain the images captured by the camera 20, and detects one or more 2D markers 10 in each image. The algorithm for detecting the 2D markers 10 may be an Aruco Marker algorithm.

The position information and appearance information contained in the detected 2D marker(s) 10 can be obtained. The identity of the 2D marker can then be determined according to the appearance information. According to the position information, the calibration information of the camera 20 can be used to obtain the position and orientation in the three-dimensional space corresponding to the position information. The identity of each detected 2D marker, as well as the 3D position and the 3D orientation of each detected 2D marker are then output as the tracking result of the exoskeleton 100 through the display device of the computer device 30.

In one embodiment, the computer device 30 can draw a motion curve as the motion trajectory of the exoskeleton according to the order of generating the 3D position and 3D orientation of each 2D marker detected (i.e., captured) from the captured images, according to the 3D position and 3D orientation corresponding to the identity of each detected 2D marker, and output the motion trajectory through the display device of the computer device 30.

By calibrating the camera 20, the transformation relationship between the points on the surface of the 2D markers captured by the camera and the corresponding points in the captured images can be determined. Therefore, the computer device 30 can determine the 3D position and 3D orientation of the detected 2D markers based on the 2D images of the 2D markers 10 captured by the camera. The 3D position and 3D orientation are the three-dimensional position and orientation on the exoskeleton where the 2D markers are located.

Based on the motion of the exoskeleton, the 2D markers associated with the motion and captured by the camera move together with the exoskeleton. A transformation matrix of 3D position and 3D orientation can be obtained for each 2D marker. The transformation matrix is the transformation matrix from the 2D markers to the camera. The position motion trajectory of each 2D marker can be obtained through the transformation matrix, and a motion curve representing the motion trajectory of the exoskeleton is drawn according to the position motion trajectory.

If one of the three linked 2D markers is captured, a transformation matrix of the 3D position and 3D orientation of the 2D marker is obtained for the joint or movable part of the exoskeleton where the 2D marker is located, and the position motion trajectory of the 2D marker can be determined according to the transformation matrix. That is, the motion trajectory of the joint or movable part of the exoskeleton where the 2D marker is located.

If two of the three linked 2D markers are captured, then for the joints or movable parts of the exoskeleton where the two 2D markers are located, two transformation matrices of the three-dimensional positions and three-dimensional orientations of the two two-dimensional markers are obtained, and the position motion trajectories of the 2D markers are determined according to the two transformation matrices.

If all of the three linked 2D markers are captured, then for the joints or movable parts of the exoskeleton where the three 2D markers are located, three transformation matrices of 3D positions and 3D orientations are obtained, and the motion trajectory of the exoskeleton is predicted based on the three transformation matrices.

If two or three of the three 2D markers are captured, according to the specific positions of the two or three 2D markers at the joints or movable parts of the exoskeleton, the transformation matrix corresponding to one of the 2D markers can be selected to determine the motion trajectory of the position of the 2D marker, that is, the motion trajectory of the joint or movable part of the exoskeleton where the 2D marker is located. The position of the 2D marker can more accurately represent the joint or movable part of the exoskeleton than the positions of the other 2D markers, such as being closer to the center of the joint or movable part of the exoskeleton. The 2D marker can be the 2D marker in the middle of the three linked 2D markers.

In another embodiment, the average value is determined according to the values in the transformation matrices corresponding to the two or three 2D markers to obtain the average value transformation matrix. The position motion trajectory determined according to the average transformation matrix is determined as the position motion trajectory of the two or three 2D markers, that is, the motion trajectory of the joint or movable part of the exoskeleton where the two or three two-dimensional markers are located.

In yet another embodiment, the two captured 2D markers are the two 2D markers located on the left and right of the three 2D markers linked together. Based on the two 2D markers, the positional relationship between the two 2D markers and the 2D marker between them, and the transformation matrices of the two 2D markers, the transformation matrix of the 2D marker located between the two 2D markers is obtained. The position motion trajectory determined according to the transformation matrix of the 2D marker located between them is determined as the position motion trajectory of the two 2D markers, that is, the motion trajectory of the joints or movable parts of the exoskeleton where the two two-dimensional markers are located.

In the above-mentioned embodiments, a single camera 20 is employed, which can save the construction cost of the tracking system, reduce the amount of data for processing the images taken by the camera, and improve the data processing speed.

In one embodiment, the computer device 30 may include one or more processors, a storage and the display device as discussed above. The one or more processors can execute the following steps: Controlling the camera 20 to capture the exoskeleton 100 when the exoskeleton 100 moves to obtain a number of images from the camera 20; for each image of the obtained images, detecting the 2D marker(s) in the image, obtaining the position information and the appearance information contained in the 2D marker(s), determining an identity of each detected 2D marker based on the obtained appearance information, and obtaining, based on the obtained position information, corresponding 3D position and 3D orientation; and outputting the identities, the 3D positions and the 3D orientations of the 2D markers as a tracking result of the robotic exoskeleton on the display device.

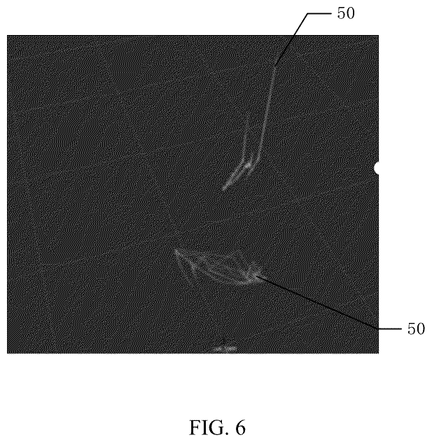

The computer device 30 can draw the 3D motion trajectory of the exoskeleton according to the tracking result, and display the 3D motion trajectory through the display device, as shown in FIG. 6, which includes 3D motion trajectories 50 of the linkage members of the exoskeleton based on 2D markers 10.

The above-mentioned steps of controlling the camera to capture images, processing the 2D markers, and outputting the tracking result of the motion trajectory of the exoskeleton by the computer device 30 can also be completed by a processor arranged in the exoskeleton 100. After the processor has executed the above-mentioned steps, the tracking result can be sent to the display device of the computer device 30 for display.

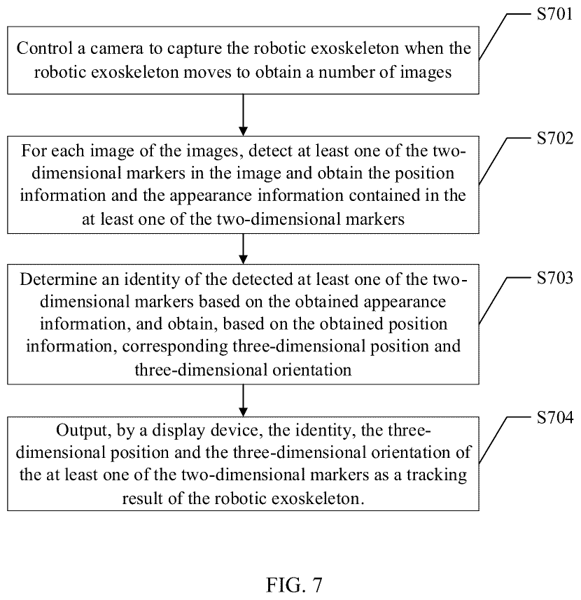

Referring to FIG. 7, the present disclosure further provides a motion tracking method for a robotic exoskeleton, which can be implemented by the above-mentioned motion tracking system to obtain the motion trajectory of the robotic exoskeleton 100. In one embodiment, the method may include the following steps S701 through S704.

Step S701: Control a camera to capture the robotic exoskeleton when the robotic exoskeleton moves to obtain a number of images.

Step S702: For each image of the images, detect at least one of the two-dimensional markers in the image and obtain the position information and the appearance information contained in the at least one of the two-dimensional markers.

In one embodiment, an Aruco marker algorithm may be employed to detect the 2D marker(s) in each image.

Step S703: Determine an identity of the detected at least one of the two-dimensional markers based on the obtained appearance information, and obtain, based on the obtained position information, corresponding three-dimensional position and three-dimensional orientation.

Step S704: Output, by a display device, the identity, the three-dimensional position and the three-dimensional orientation of the at least one of the two-dimensional markers as a tracking result of the robotic exoskeleton.

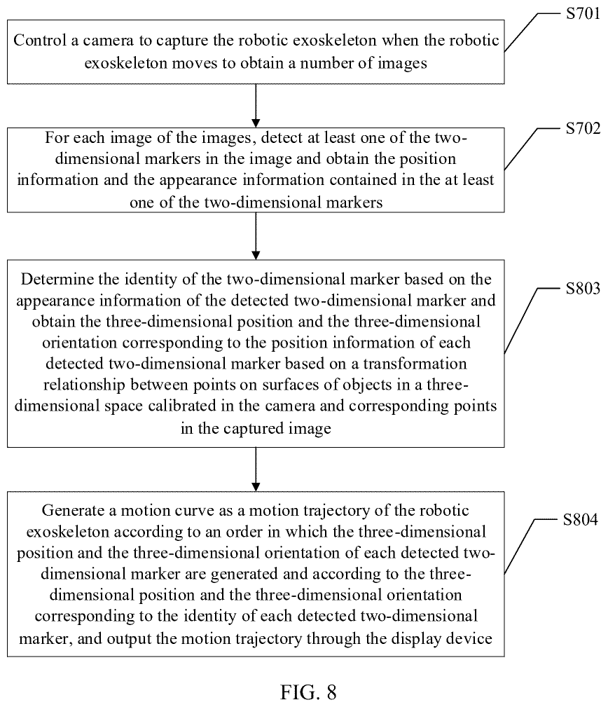

Referring to FIG. 8, in one embodiment, step S703 may include Step S803.

Step S803: Determine the identity of the two-dimensional marker based on the appearance information of the detected two-dimensional marker and obtain the three-dimensional position and the three-dimensional orientation corresponding to the position information of each detected two-dimensional marker based on a transformation relationship between points on surfaces of objects in a three-dimensional space calibrated in the camera and corresponding points in the captured image.

In one embodiment, step S704 may include step S804.

Step S804: Generate a motion curve as a motion trajectory of the robotic exoskeleton according to an order in which the three-dimensional position and the three-dimensional orientation of each detected two-dimensional marker are generated and according to the three-dimensional position and the three-dimensional orientation corresponding to the identity of each detected two-dimensional marker, and output the motion trajectory through the display device.

Specifically, when the robotic exoskeleton moves, the transformation matrix of the three-dimensional position and the three-dimensional orientation of each of the two-dimensional markers detected (i.e., in the captured image) can be obtained. The position motion trajectory of the two-dimensional marker(s) can be obtained through the transformation matrix, the motion curve can be drawn according to the position motion trajectory, and the motion curve can be used as the motion trajectory of the exoskeleton where the two-dimensional markers are located.

In the above-mentioned embodiment, at least three non-coplanar linked two-dimensional markers are arranged on the robotic exoskeleton, this redundancy helps overcome issues caused by single light sources. Even with a single camera, when one or two 2D markers are blocked due to the capturing angle or the influence of a blocking object, the camera can still capture one 3D marker from any angle and any position. Each of the 2D markers contains unique position information and unique appearance information. The computer device can control the camera to capture the exoskeleton in motion and obtain the captured images from the camera. The computer device can identify a 2D marker in each obtained image and obtain the position information and appearance information contained in the 2D marker. The computer device can determine the 3D position and 3D orientation of the 2D marker according to the position information and the appearance information. The 3D position and 3D orientation are used as the tracking result of the robotic exoskeleton, and the tracking result is output through a display device of the computer device, so that the exoskeleton can be tracked in all the working spaces of the exoskeleton. The above-mentioned recognition and tracking of the 2D marker overcome the reflection and noise from the environment, and can reduce the errors of the two-dimensional marker detection and the exoskeleton posture estimation.

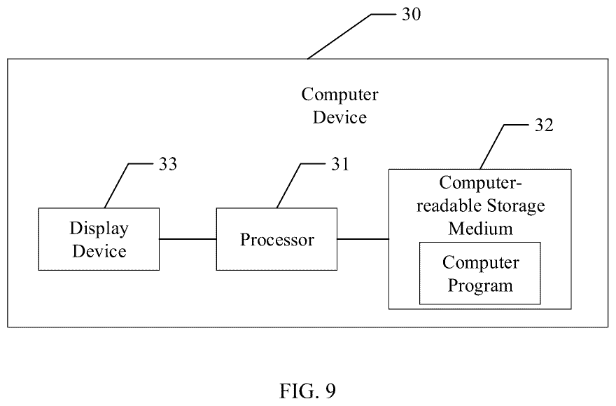

Another aspect of the present disclosure is directed to a non-transitory computer-readable storage medium 32 arranged in the computer device 30. Referring to FIG. 9, in one embodiment, the computer device 30 may include a processor 31, the storage medium 32 and the display device 30. The storage medium 32 is electrically coupled to the processor 31. The storage medium 32 stores a computer program, which, when executed by the processor 31, causes the processor 31 to perform the motion tracking method as discussed in the foregoing embodiments.

A person skilled in the art can understand that all or part of the processes in the above-mentioned embodiments can be implemented by instructing the relevant hardware through a computer program. The above-mentioned computer program can be stored in a non-volatile computer-readable storage medium. When the computer program is executed, the processes of the embodiments of the above-mentioned methods are performed. Any reference to memory, storage, database or other mediums provided in this disclosure and used in the embodiments may include a non-volatile and/or volatile storage. Non-volatile storages may include read-only memory (ROM), programmable ROM (PROM), electrically programmable ROM (EPROM), electrically erasable programmable ROM (EEPROM) or flash memory. Volatile storages may include random access memory (RAM) or external cache memory. As an illustration rather than a limitation, RAM is available in many forms, such as static RAM (SRAM), dynamic RAM (DRAM), synchronous DRAM (SDRAM), dual data rate SDRAM (SSRSDRAM), enhanced SDRAM (ESDRAM), synchronous link DRAM (SLDRAM), memory bus direct RAM (RDRAM), direct memory bus dynamic RAM (DRDRAM), and memory bus dynamic RAM (RDRAM).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A motion tracking system for a robotic exoskeleton with a plurality of groups of two-dimensional markers arranged at designated positions thereof, each group of the plurality of groups of two-dimensional markers comprising at least three linked two-dimensional markers that are non-coplanar, and each of the two-dimensional markers containing unique position information and unique appearance information, the motion tracking system comprising:
a computer device configured to:
control a camera to capture the robotic exoskeleton when the robotic exoskeleton moves to obtain a plurality of images;
for each image of the images, detect at least one of the two-dimensional markers in the image, obtain the position information and the appearance information contained in the at least one of the two-dimensional markers, determine an identity of the detected at least one of the two-dimensional markers based on the obtained appearance information, and obtain, based on the obtained position information, corresponding three-dimensional position and three-dimensional orientation;
output, by the computer device, the identity, the three-dimensional position and the three-dimensional orientation of the at least one of the two-dimensional markers as a tracking result of the robotic exoskeleton.

2. The motion tracking system of claim 1, wherein an angle between two adjacent ones of each group of the plurality of groups of two-dimensional markers is greater than 0 degrees and less than or equal to 135 degrees.

3. The motion tracking system of claim 1, wherein when the at least three linked two-dimensional markers are three in number, among the three two-dimensional markers, angles between the two-dimensional marker located in the middle and the two adjacent two-dimensional markers are equal.

4. The motion tracking system of claim 1, wherein each group of the plurality of groups of two-dimensional markers is arranged at a joint or a movable part of the robotic exoskeleton.

5. The motion tracking system of claim 1, wherein the computer device is configured to obtain the three-dimensional position and the three-dimensional orientation corresponding to the position information of each detected two-dimensional marker based on a transformation relationship between points on surfaces of objects in a three-dimensional space calibrated in the camera and corresponding points in the captured image.

6. The motion tracking system of claim 5, wherein the computer device is configured to generate a motion curve as a motion trajectory of the robotic exoskeleton according to an order in which the three-dimensional position and the three-dimensional orientation of each detected two-dimensional marker are generated and according to the three-dimensional position and the three-dimensional orientation corresponding to the identity of each detected two-dimensional marker, and output the motion trajectory through a display device.

7. The motion tracking system of claim 6, wherein when the robotic exoskeleton moves, the computer device is configured to: obtain a transformation matrix for the three-dimensional position and the three-dimensional orientation of each detected two-dimensional marker, obtain a position motion trajectory of each detected two-dimensional marker through the transformation matrix, draw the motion curve according to the position motion trajectory, and determine the motion curve as the motion trajectory of the robotic exoskeleton where the two-dimensional marker is located.

8. A computer-implemented motion tracking method for a robotic exoskeleton with a plurality of groups of two-dimensional markers arranged at designated positions thereof, each group of the plurality of groups of two-dimensional markers comprising at least three linked two-dimensional markers that are non-coplanar, and each of the two-dimensional markers containing unique position information and unique appearance information, the method comprising:
controlling a camera to capture the robotic exoskeleton when the robotic exoskeleton moves to obtain a plurality of images;
for each image of the images, detecting at least one of the two-dimensional markers in the image and obtaining the position information and the appearance information contained in the at least one of the two-dimensional markers;
determining an identity of the detected at least one of the two-dimensional markers based on the obtained appearance information, and obtaining, based on the obtained position information, corresponding three-dimensional position and three-dimensional orientation; and
outputting, by a display device, the identity, the three-dimensional position and the three-dimensional orientation of the at least one of the two-dimensional markers as a tracking result of the robotic exoskeleton.

9. The method of claim 8, wherein an angle between two adjacent ones of each group of the plurality of groups of two-dimensional markers is greater than 0 degrees and less than or equal to 135 degrees.

10. The method of claim 8, wherein when the at least three linked two-dimensional markers are three in number, among the three two-dimensional markers, angles between the two-dimensional marker located in the middle and the two adjacent two-dimensional markers are equal.

11. The method of claim 8, wherein each group of the plurality of groups of two-dimensional markers is arranged at a joint or a movable part of the robotic exoskeleton.

12. The method of claim 8, wherein obtaining, based on the obtained position information, corresponding three-dimensional position and three-dimensional orientation comprises: obtaining the three-dimensional position and the three-dimensional orientation corresponding to the position information of each detected two-dimensional marker based on a transformation relationship between points on surfaces of objects in a three-dimensional space calibrated in the camera and corresponding points in the captured image.

13. The method of claim 12, wherein outputting, by the display device, the identity, the three-dimensional position and the three-dimensional orientation of the at least one of the two-dimensional markers as the tracking result of the robotic exoskeleton comprises: generating a motion curve as a motion trajectory of the robotic exoskeleton according to an order in which the three-dimensional position and the three-dimensional orientation of each detected two-dimensional marker are generated and according to the three-dimensional position and the three-dimensional orientation corresponding to the identity of each detected two-dimensional marker, and output the motion trajectory through the display device.

14. The method of claim 13, wherein generating the motion curve as the motion trajectory of the robotic exoskeleton according to the order in which the three-dimensional position and the three-dimensional orientation of each detected two-dimensional marker are generated and according to the three-dimensional position and the three-dimensional orientation corresponding to the identity of each detected two-dimensional marker comprises:
when the robotic exoskeleton moves, obtaining a transformation matrix for the three-dimensional position and the three-dimensional orientation of each detected two-dimensional marker; and
obtaining a position motion trajectory of each detected two-dimensional marker through the transformation matrix, and drawing the motion curve according to the position motion trajectory, and determining the motion curve as the motion trajectory of the robotic exoskeleton where the two-dimensional marker is located.

15. A non-transitory computer-readable storage medium storing instructions that, when executed by at least one processor of amotion tracking system for a robotic exoskeleton with a plurality of groups of two-dimensional markers arranged at designated positions thereof, each group of the plurality of groups of two-dimensional markers comprising at least three linked two-dimensional markers that are non-coplanar and each of the two-dimensional markers containing unique position information and unique appearance information, cause the at least one processor to perform a motion tracking method, the method comprising:
controlling a camera to capture the robotic exoskeleton when the robotic exoskeleton moves to obtain a plurality of images;
for each image of the images, detecting at least one of the two-dimensional markers in the image and obtaining the position information and the appearance information contained in the at least one of the two-dimensional markers;
determining an identity of the detected at least one of the two-dimensional markers based on the obtained appearance information, and obtaining, based on the obtained position information, corresponding three-dimensional position and three-dimensional orientation; and
outputting, by a display device, the identity, the three-dimensional position and the three-dimensional orientation of the at least one of the two-dimensional markers as a tracking result of the robotic exoskeleton.

16. The non-transitory computer-readable storage medium of claim 15, wherein an angle between two adjacent ones of each group of the plurality of groups of two-dimensional markers is greater than 0 degrees and less than or equal to 135 degrees.

17. The non-transitory computer-readable storage medium of claim 15, wherein when the at least three linked two-dimensional markers are three in number, among the three two-dimensional markers, angles between the two-dimensional marker located in the middle and the two adjacent two-dimensional markers are equal.

18. The non-transitory computer-readable storage medium of claim 15, wherein obtaining, based on the obtained position information, corresponding three-dimensional position and three-dimensional orientation comprises: obtaining the three-dimensional position and the three-dimensional orientation corresponding to the position information of each detected two-dimensional marker based on a transformation relationship between points on surfaces of objects in a three-dimensional space calibrated in the camera and corresponding points in the captured image.

19. The non-transitory computer-readable storage medium of claim 18, wherein outputting, by the display device, the identity, the three-dimensional position and the three-dimensional orientation of the at least one of the two-dimensional markers as the tracking result of the robotic exoskeleton comprises: generating a motion curve as a motion trajectory of the robotic exoskeleton according to an order in which the three-dimensional position and the three-dimensional orientation of each detected two-dimensional marker are generated and according to the three-dimensional position and the three-dimensional orientation corresponding to the identity of each detected two-dimensional marker, and output the motion trajectory through the display device.

20. The non-transitory computer-readable storage medium of claim 19, wherein generating the motion curve as the motion trajectory of the robotic exoskeleton according to the order in which the three-dimensional position and the three-dimensional orientation of each detected two-dimensional marker are generated and according to the three-dimensional position and the three-dimensional orientation corresponding to the identity of each detected two-dimensional marker comprises:
when the robotic exoskeleton moves, obtaining a transformation matrix for the three-dimensional position and the three-dimensional orientation of each detected two-dimensional marker; and
obtaining a position motion trajectory of each detected two-dimensional marker through the transformation matrix, and drawing the motion curve according to the position motion trajectory, and determining the motion curve as the motion trajectory of the robotic exoskeleton where the two-dimensional marker is located.
